(19) United States
(12) Patent Application Publication
(10) Pub. No.: US 2013/0179826 A1
(43) Pub. Date: Jul. 11, 2013

(54) DEVICE, METHOD, AND USER INTERFACE FOR COMMAND ASSIGNMENT

(71) Applicants: SHIH-CHENG WANG, Tu-Cheng (TW); YI-WEN CAI, Tu-Cheng (TW)

(72) Inventors: SHIH-CHENG WANG, Tu-Cheng (TW); YI-WEN CAI, Tu-Cheng (TW)

(73) Assignee: HON HAI PRECISION INDUSTRY CO., LTD., Tu-Cheng (TW)

(21) Appl. No.: 13/345,674

(22) Filed: Jan. 7, 2012

(51) Int. Cl. G06F 3/048

(52) U.S. Cl. 715/781; 715/764

(57) ABSTRACT

A command assignment device is provided. The command assignment device includes software modules which include instructions: to display a floor plan diagram corresponding to a scene on a screen display; to display a symbol on the floor plan diagram according to a responder device location information received from a responder device located at the scene; to generate a destination correlation information in response to detecting a correlation operation between the responder symbol and a destination on the floor plan diagram; to generate an action information in response to various actions taken; and to transmit a command signal comprising any commands given for display on the responder device(s). The disclosure further provides a command assignment method and a command assignment interface.

### BACKGROUND

1. Technical Field

The present disclosure relates to a command assignment device, a command assignment method, and a command assignment interface, and particularly to a command assignment device, a command assignment method, and a command assignment interface interacting with a responder interface of a responder device.

2. Description of Related Art

In an emergency, a commander usually uses a public safety radio to communicate with the emergency responders in the scene of the emergency. However, the commander may be incapable of providing commands effectively and precisely because of inexperience or the confusing nature of some emergency situations. In addition, the emergency responders may be incapable of comprehending the commands when they are unfamiliar with the scene.

Thus, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a command assignment device of the present disclosure.

FIG. 2 is a flowchart of a first embodiment of a command assignment method implemented through the command assignment device of FIG. 1.

FIGS. 3A/3B is a flowchart of a second embodiment of a command assignment method implemented through the command assignment device of FIG. 1.

FIG. 4A is a schematic view of an embodiment of a user interface implemented through the command assignment device of FIG. 1.

FIG. 4B is a schematic view of a first embodiment of a process of using the user interface of FIG. 4A in assignment mode.

FIG. 4C is a schematic view of a second embodiment of a process of using the user interface of FIG. 4A in assignment mode.

FIG. 4D is a schematic view of an embodiment of a process of using the user interface of FIG. 4A in guidance mode.

FIG. 4E is a schematic view of an embodiment of a process of using the user interface of FIG. 4A in scene mode.

FIG. 5 is a schematic view of another embodiment of a user interface implemented through the command assignment device of FIG. 1.

### DETAILED DESCRIPTION

In general, the disclosure relates to command assignment interfaces, electronic devices with a command assignment interface, and methods for operating command assignment interfaces. The invention is particularly suitable for use with electronic devices with a touch-sensitive display.

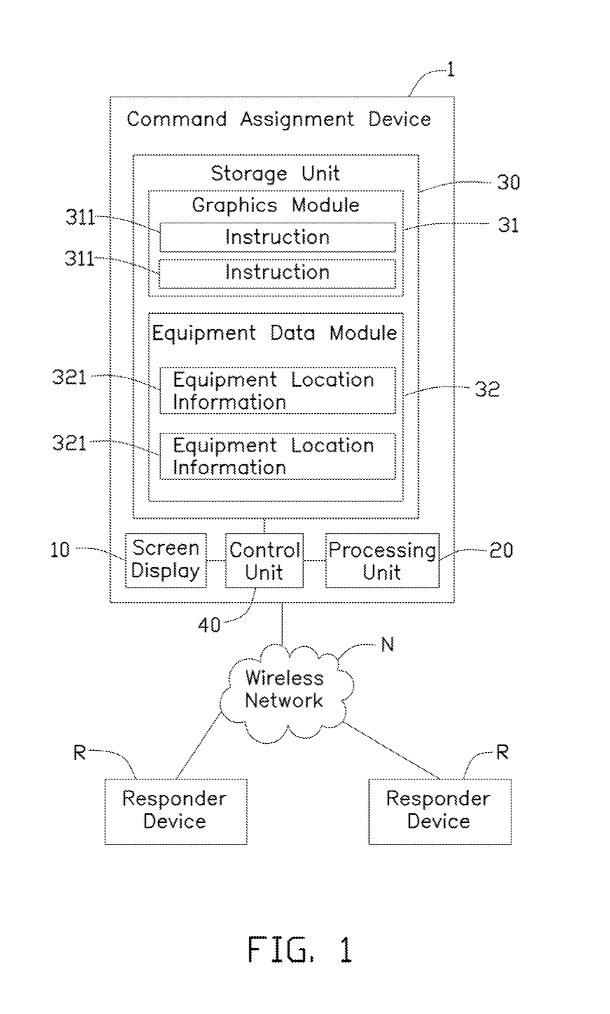

FIG. 1 is a block diagram of an embodiment of a command assignment device 1 of the present disclosure. The command assignment device 1 includes a screen display 10, a processing unit 20, a storage unit 30, and a control unit 40. In the illustrated embodiment, the command assignment device 1 is a portable device such as a tablet computer, a notebook computer, or a smart phone, and the screen display 10 is a touch-sensitive display. In other embodiments, the command assignment device 1 can be a stationary device such as a desktop personal computer, and the screen display 10 can be another type of electronic display such as a liquid crystal display (LCD) or an electronic paper display. The command assignment device 1 is capable of receiving information as to the location(s) of one or more responder devices R (responder device location information Ir (not shown)) received from the one or more responder device R in a particular place or location (particular scene) through a wireless network N implemented according to a telecommunication standard such as WI-FI or BLUETOOTH. The processing unit 20 may include a central processing unit (CPU), which communicates with the screen display 10 and the storage unit 30 via the control unit 40. The storage unit 30 may include a high speed random access memory and may also include a non-volatile memory, which stores a graphics module 31 available to the processing unit 20 and an equipment data module 32. The graphics module 31 includes instructions 311 for implementing functions relating to one or more graphic user interfaces (GUIs). The equipment data module 32 may include a database, which is capable of storing equipment location information 321 of equipment such as water hydrants located in the particular scene. The control unit 40 may include controller devices including memory controllers, peripheral device interfaces, and I/O subsystems.

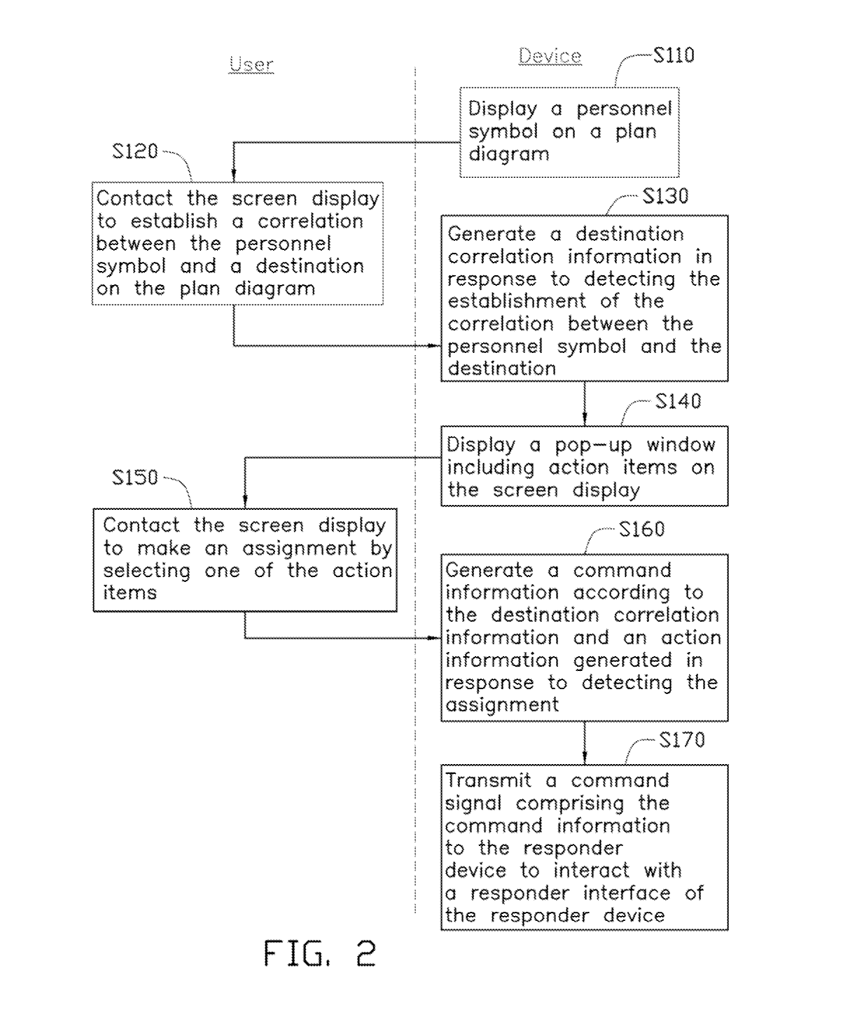

FIG. 2 is a flowchart of a first embodiment of a command assignment method implemented through the command assignment device 1 of FIG. 1. The command assignment method of the present disclosure is as follows. The steps are implemented through the instructions 311 stored in the graphics module 31 of the storage unit 30. Depending on the embodiment, additional steps may be added, others removed, and the ordering of the steps may be changed.

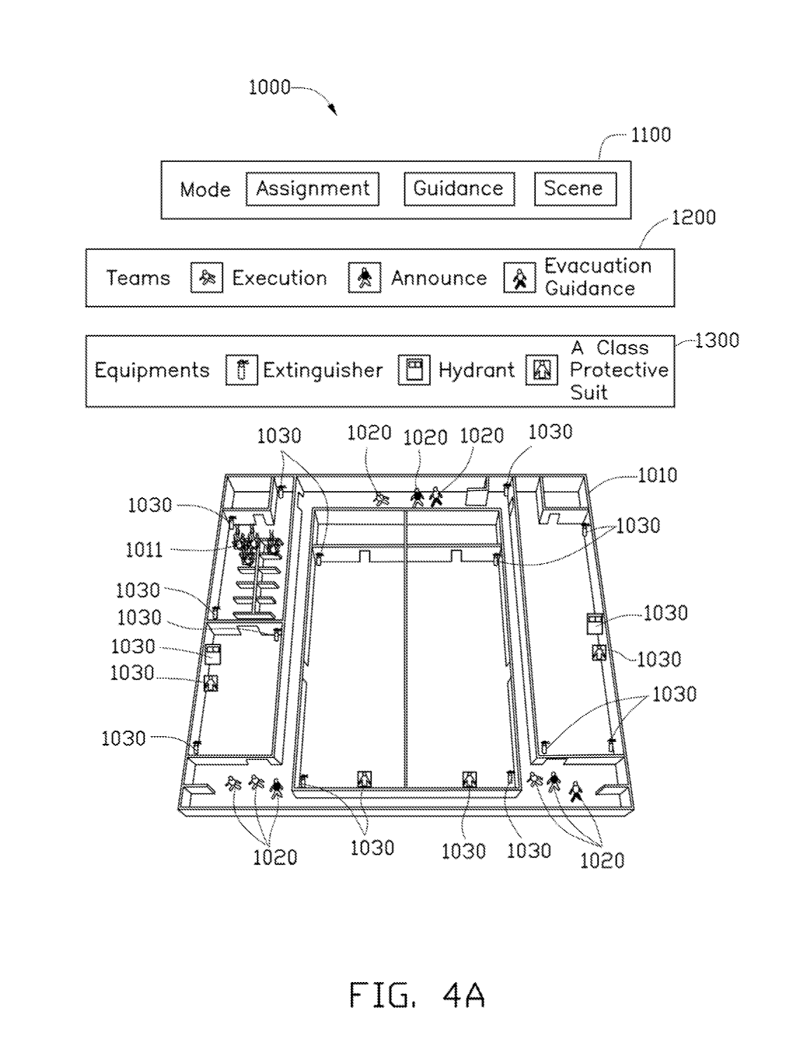

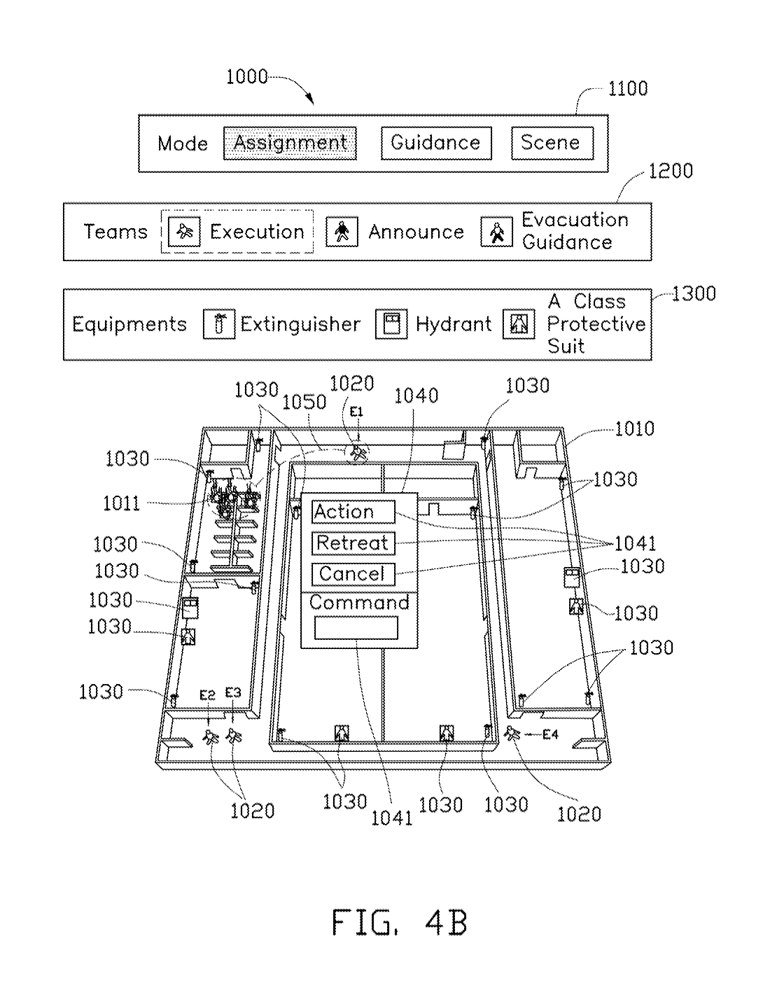

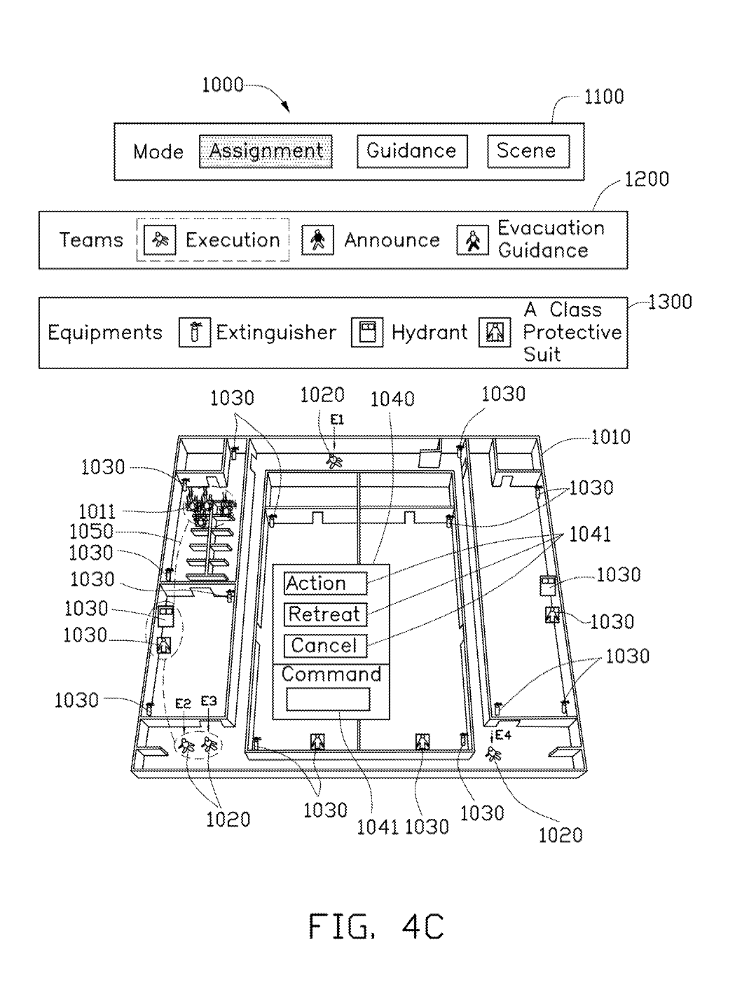

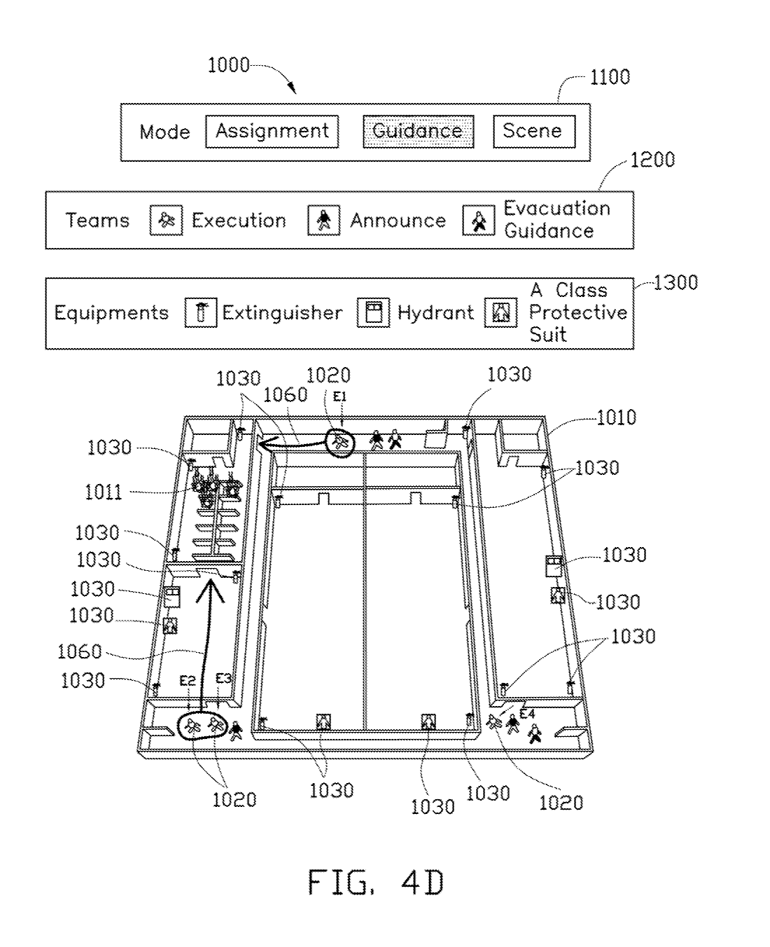

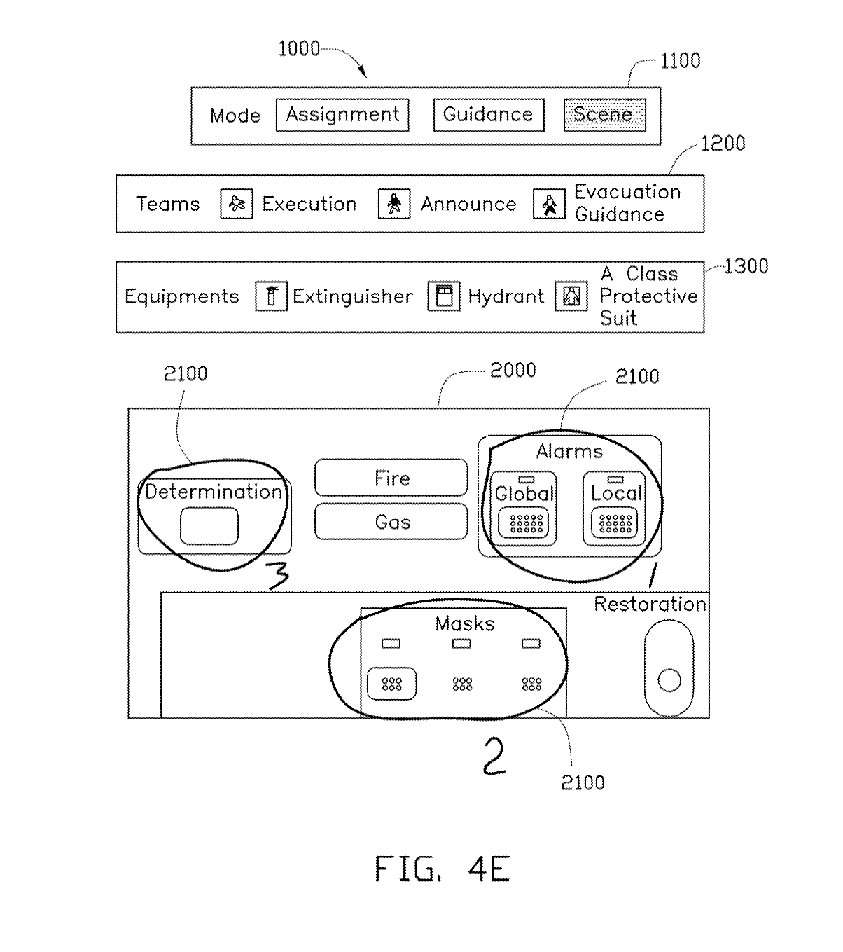

In step S110, a floor plan diagram 1010 (see FIG. 4A) corresponding to the particular scene is displayed on the screen display 10, and a personnel symbol 1020 (see FIG. 4A) is displayed on the floor plan diagram 1010 according to the responder device location information Ir.

In step S120, the screen display 10 receives an instruction from the user of the command assignment device 1 to establish a correlation between the personnel symbol 1020 and a destination 1011 (see FIG. 4A) on the floor plan diagram 1010.

In step S130, a destination correlation information Id (not shown) is generated as a response when the establishment of the correlation between the personnel symbol 1020 and the destination 1011 has occurred.

In step S140, a pop-up window 1040 (see FIG. 4B) including action items 1041 (see FIG. 4B) is displayed on the screen display 10.

In step S150, the screen display 10 receives an instruction from the user of the command assignment device 1 to make an assignment by selecting one of the action items 1041. In other embodiments, the assignment can be made by other methods, for instance, inputting a command through a keyboard or a microphone connected to the command assignment device 1.

In step S160, a command information Ic (not shown) is generated according to the destination correlation information Id and an action information Ia (not shown), the action information Ia being generated as a response when the assignment with respect to the action items has been detected.

In step S170, a command signal including the command information Ic is transmitted to the responder device R to interact by means of a responder interface of the responder device R.

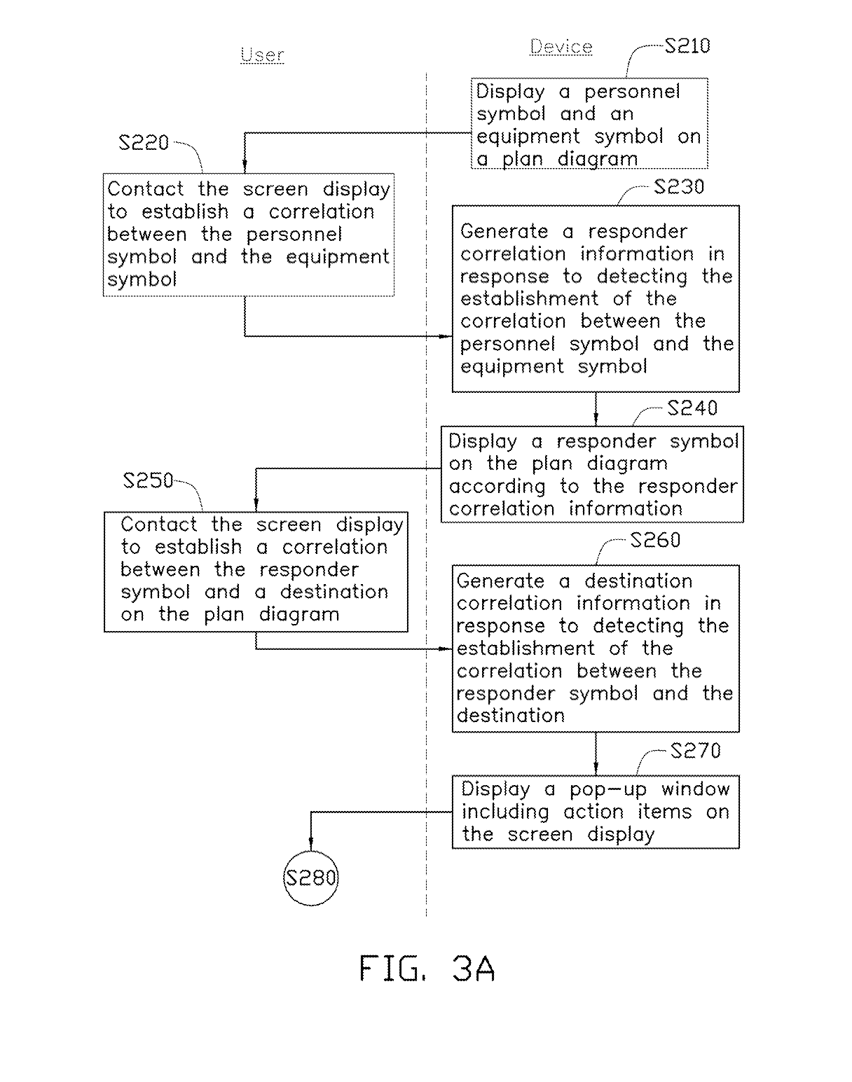

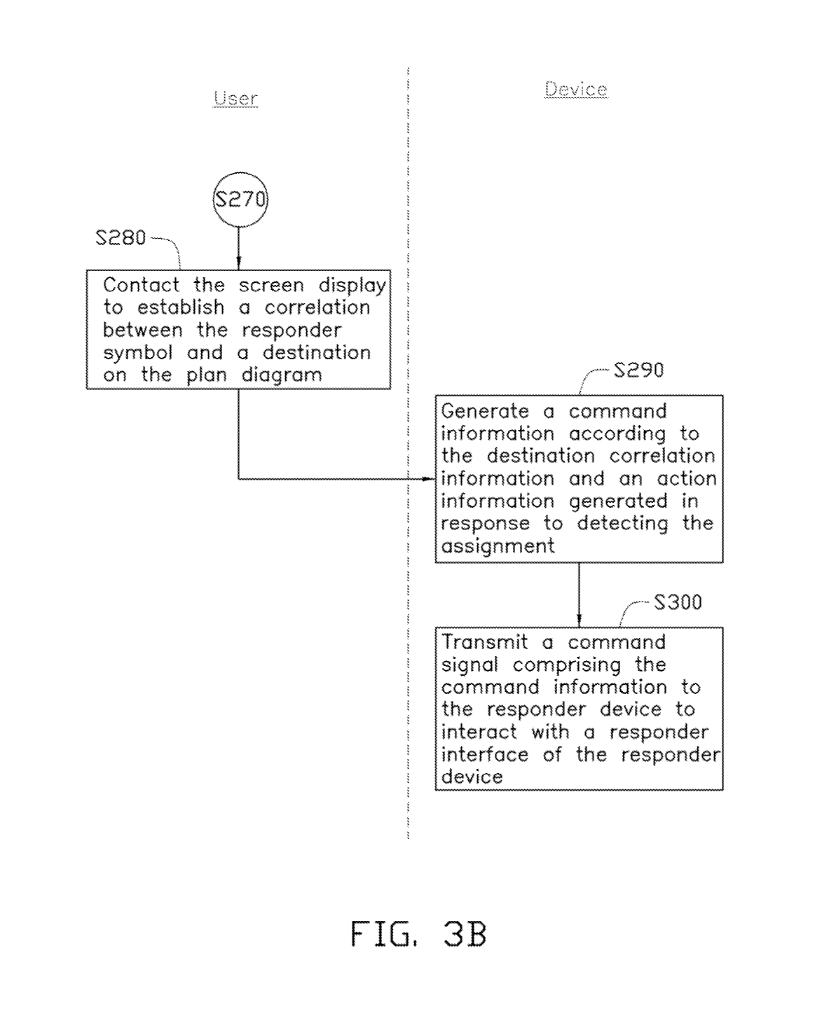

FIGS. 3A and 3B shows a flowchart of a second embodiment of a command assignment method implemented through the command assignment device 1 of FIG. 1. The command assignment method of this disclosure is as follows. Depending on the embodiment, additional steps may be added, others removed, and the ordering of the steps may be changed.

In step S210, the floor plan diagram 1010 corresponding to the particular scene is displayed on the screen display 10, the personnel symbol 1020 is displayed on the floor plan diagram 1010 according to the responder device location information Ir, and an equipment symbol 1030 (see FIG. 4A) is also displayed on the floor plan diagram 1010 according to the equipment location information 321.

In step S220, the screen display 10 receives an instruction from the user of the command assignment device 1 to establish a correlation between the personnel symbol 1020 and the equipment symbol 1030.

In step S230, a responder correlation information Ir (not shown) is generated as a response once the establishment of the correlation between the personnel symbol 1020 and the equipment symbol 1030 has taken place.

In step S240, a combination symbol 1050 (see FIG. 4C) is displayed on the floor plan diagram 1010 according to the responder correlation information Ir

In step S250, the screen display 10 receives an instruction from the user of the command assignment device 1 to establish a correlation between the combination symbol 1050 and the destination 1011 on the floor plan diagram 1010.

In step S260, the destination correlation information Id is generated as a response to the establishment of the correlation between the combination symbol 1050 and the destination 1011.

In step S270, the pop-up window 1040 including the action items 1041 is displayed on the screen display 10.

In step S280, the screen display 10 receives an instruction from the user of the command assignment device 1 to make an assignment by selecting one of the action items.

In step S290, the action information Ia is generated as a response after the assignment with respect to the action items has taken place, and a command information Ic (not shown) is generated according to the destination correlation information Id and the action information Ia.

In step S300, a command signal including the command information Ic is transmitted to the responder device R to interact by means of the responder interface of the responder device R.

FIG. 4A is a schematic view of an embodiment of a user interface 1000 implemented through the command assignment device 1 of FIG. 1. The user interface 1000 is a GUI displayed through the screen display 10 (see FIG. 1) and includes the floor plan diagram 1010, a mode list 1100, a team list 1200, and an equipment list 1300. The mode list 1100 includes three buttons which represent an assignment mode, a guidance mode, and a scene mode which can be selected or changed by, for instance, making contact with the screen display 10 or by moving a cursor displayed on the screen display 10. In the illustrated embodiment, the team list 1200 includes three items representing the execution team, the announce team, and the evacuation guidance team of personnel, any or all of which can be selected or de-selected by, for instance, making contact with the screen display 10 or by moving a cursor displayed on the screen display 10, to show the particular team(s) selected on the floor plan diagram 1010. The equipment list 1300 includes three items representing fire extinguishers, water hydrants, and A class protective suits, which can be selected or de-selected by, for instance, making contact with the screen display 10 or by moving a cursor displayed on the screen display 10, to indicate the particular type(s) of equipment selected, and displayed as such on the floor plan diagram 1010. In other embodiments, the quantity or number of each type of equipment can be shown and increased or decreased after initial allocation. The personnel symbol 1020 is displayed on the floor plan diagram 1010 according to the responder device location information Ir when the responder device R which corresponds to the responder device location information Ir is at the particular scene, and the personnel symbol 1020 is a graphical, interactive user-interface object-image such as an icon, to represent the location of emergency personnel, which can be dragged or otherwise moved on the screen display 10. The equipment symbol 1030 is displayed on the floor plan diagram 1010 according to the equipment location information 321 when the corresponding equipment is actually located in the particular scene, and the equipment symbol 1030 is a graphical, interactive user-interface object-image such as an icon, to represent the location of equipment, which can be dragged or otherwise moved on the screen display 10. In the illustrated embodiment, the destination 1011 is displayed according to one or more sensor signals received from the one or more sensors disposed in the particular scene. In another embodiment, the destination 1011 can be manually designated.

FIG. 4B is a schematic view of a first embodiment of the use of the user interface 1000 of FIG. 4A in assignment mode. In the assignment mode, the user interface 1000 can be operated to interact with the responder interface of the responder device R. Once a correlation between the personnel symbols 1020 and the destination 1011 on the floor plan diagram 1010 has been established, the destination correlation information Id is generated. A combination symbol 1050 which is a graphical user-interface object-image representing the correlation of the personnel symbol 1020 and the destination 1011 may be displayed according to the destination correlation information Id, and the pop-up window 1040 including the action items 1041 is also displayed. The action items 1041 include an action button, a retreat button, and a cancel button, any of which can be actuated to actually issue an assignment, and a command line wherein commands can be inputted. The pop-up window 1040 and the combination symbol 1050 are closed after the actuation of one of the buttons. In the illustrated embodiment, a graphical, interactive user-interface object-image enclosing the personnel symbol 1020 is produced and displayed when a correlation between the personnel symbol 1020 and the destination 1011 has been established by, for instance, making contact with the screen display 10 or by moving a cursor displayed on the screen display 10, to move the personnel symbol 1020 to the inside of the destination 1011 or to enclose the destination 1011. In other embodiments, the correlation can be performed by other methods, for instance, by moving a cursor displayed on the screen display 10 to the personnel symbol 1020 through a mouse connected to the command assignment device 1, clicking a button of the mouse, and dragging the personnel symbol 1020 to the destination 1011. In addition, the correlation can be performed by directly moving the personnel symbol 1020 to the destination 1011.

FIG. 4C is a schematic view of a second embodiment of the use of the user interface 1000 of FIG. 4A in assignment mode. Once a correlation between two of the personnel symbols 1020 and two of the equipment symbols 1030 has been established, the responder correlation information Ir is generated, and a graphical, interactive user-interface object-image correlating the two personnel symbols 1020 and the two equipment symbols 1030 is displayed according to the responder correlation information Ir. When a correlation between the user-interface object-image (which correlated the two personnel symbols 1020 and the two equipment symbols 1030) and the destination 1011 on the floor plan diagram 1010 has been established, the destination correlation information Id is generated, and in the illustrated embodiment, the equipment symbols 1030 are dimmed to signify that the equipment symbols 1030 have been allocated and correlated, that is, the equipment symbols 1030 to be used. A combination symbol 1050, which is a graphical user-interface object-image, is displayed according to the destination correlation information Id to signify the correlation of the personnel symbols 1020, the equipment symbols 1030, and the destination 1011, and the pop-up window 1040 including the action items 1041 is also displayed. In the illustrated embodiment, a graphical, interactive user-interface object-image enclosing the two personnel symbols 1020 is produced and displayed when the two personnel symbols 1020 are together, and a graphical, interactive user-interface object-image enclosing the two equipment symbols 1030 is produced and displayed when the two equipment symbols 1030 are together by, for instance, making contact with the screen display 10 or by moving a cursor displayed on the screen display 10. The correlation between the two personnel symbols 1020 and the two equipment symbols 1030 can be established by, for instance, moving the user-interface object enclosing the personnel symbols 1020 to the equipment symbols 1030 to enclose them, or by moving the user-interface object enclosing the equipment symbols 1030 to the personnel symbols 1020 to enclose them. The correlation between the user-interface object-image correlating the two personnel symbols 1020 and the two equipment symbols 1030 as well as the destination 1011 can also be established by, for instance, moving the relevant user-interface object-image(s) to the destination 1011.

When an assignment has been made with respect to one of the action items 1041 in the pop-up window 1040, the action information Ia is generated. If the action button of the action items 1041 is actuated, the action information Ia includes information for the responder interface of the responder device R to show the floor plan diagram 1010, the symbols on the floor plan diagram 1010, and the combination symbol 1050. In addition, when a command is input to the command line before actuating the action button, the action information Ia includes the command for the responder interface of the responder device R to show the command which has been inputted. If the retreat button of the action items 1041 is actuated, the action information Ia includes the information for the responder interface of the responder device R to show a message accordingly on the responder device R. If the cancel button of the action items 1041 is actuated, the action information Ia includes the information for the responder interface of the responder device R to show a message canceling the assignment on the responder device R.

The command information Ic is generated according to the destination correlation information Id and the action information Ia, and the command signal including the command information Ic is transmitted to the responder device R to interact with the responder interface of the responder device R through the command assignment device 1. The responder interface can include a graphical user interface displayed on a screen display of the responder device R.

FIG. 4D is a schematic view of an embodiment of the use of the user interface 1000 of FIG. 4A in guidance mode. In the guidance mode, a guidance information is generated according to the lines or traces made by the user of the command assignment device 1 on the floor plan diagram 1010 by, for instance, making contact with the screen display 10 or by moving a cursor displayed on the screen display 10, and a guidance signal including the guidance information is transmitted to the responder device R, wherein the responder device R can be designated as the target of the communication by, for instance, selecting the responder device R through the screen display 10 in the assignment mode. Consequently, the responder interface of the responder device R can show the floor plan diagram 1010, the symbols on the floor plan diagram 1010, and sketches 1060 so as to reveal and repeat the lines or traces drawn on the floor plan diagram 1010 in real time according to the guidance information in the guidance signal.

FIG. 4E is a schematic view of an embodiment of the use of the user interface 1000 of FIG. 4A in scene mode. In the scene mode, a scene image 2000 is displayed on the screen display 10 according to scene image signal(s) received from the responder device R. A demonstrating information is generated according to the lines or traces drawn by the user of the command assignment device 1 on the scene image 2000 through the screen display 10 or a cursor, and a demonstrating signal to include the demonstrating information is transmitted to the responder device R. The responder device R can display and repeat the scene image 2000 together with the lines or traces drawn thereon (sketches 2100) in real time as the sketches 2100 are drawn. In the illustrated embodiment, steps to operate a fire alarm control panel are shown by the sketches 2100. In addition, in other embodiments, a graphical user-interface object-image such as an icon or a button can be shown in response to receiving the scene image signal, thereby informing the user of the command assignment device 1. In the scene mode, the graphical user-interface object-image can be actuated to display the scene image 2000. In other modes, the graphical user-interface object-image can be actuated to switch the user interface 1000 to the scene mode to display the scene image 2000.

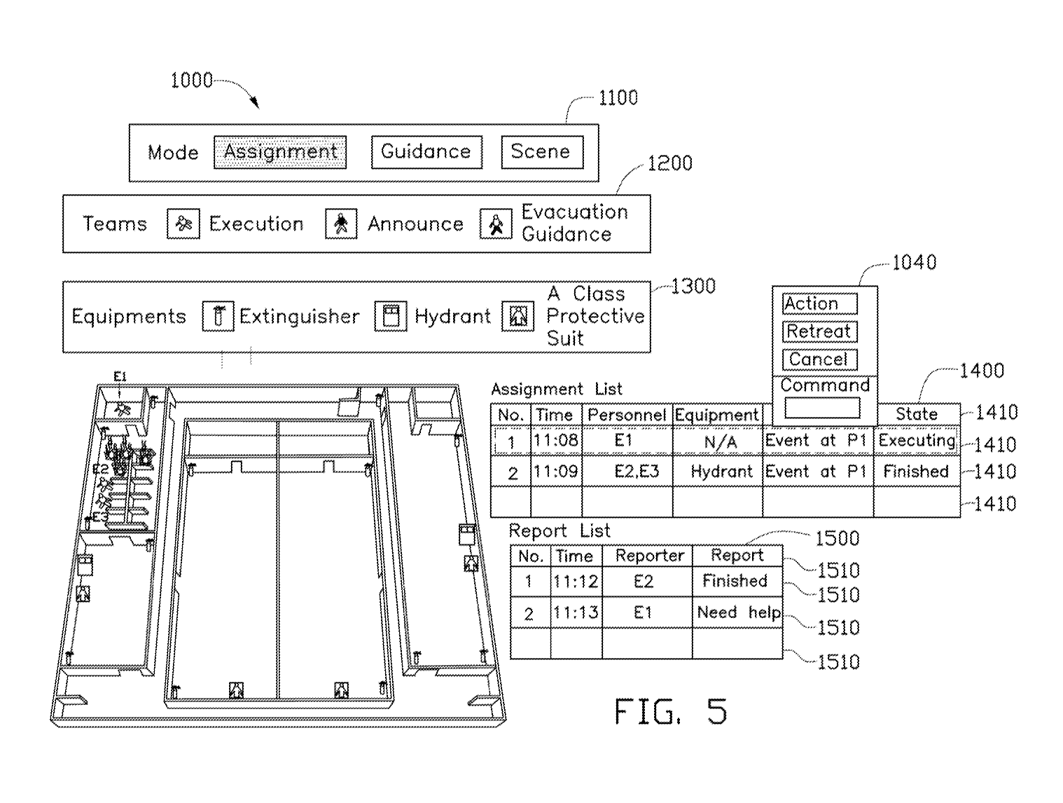

FIG. 5 is a schematic view of another embodiment of a user interface 1000 implemented through the command assignment device 1 of FIG. 1. In comparison with the user interface 1000 of FIG. 4A, the user interface 1000 further includes an assignment list 1400 including assignment items 1410 and a report list 1500 including report items 1510. Each of the assignment items 1410 is generated according to the command information Ic. In the illustrated embodiment, the assignment item 1410 includes a serial number, a time of assignment, assigned personnel, assigned equipment, a context of the assignment, and a current state of the assignment. When a selection of one of the assignment items 1410 is made, the pop-up window 1040 is displayed, and the action information Ia is displayed. The assignment(s) which generate the action information Ia may be changed, in relation to the action items 1041. The selection of the assignment items 1410 can be performed through the screen display 10 or by moving a cursor. If the action button of the action items 1041 is actuated when a command is input to the command line, the action information Ia includes the command for the responder interface of the responder device R to show the command given. If the retreat button of the action items 1041 is actuated, the action information Ia includes a message to order the user of the responder device R to retreat from the particular scene. If the cancel button of the action items 1041 is actuated, the action information Ia includes a message to the user of the responder device R to consider the assignment canceled. The pop-up window 1040 is closed after actuating one of the action items 1041. Each of the report items 1510 is generated according to a report signal Sr (not shown) received from the responder device R, wherein the report signal Sr is produced through the responder interface of the responder device R. In the illustrated embodiment, the assignment item 1410 includes a serial number, a time of report, a reporter identification, and a context of report.

The command assignment device and the command assignment method provide a very useful GUI whereby the commander in an emergency can communicate with the emergency responders at the scene of the emergency. Since commands can be made and provided graphically to the emergency responders, the commander can issue commands precisely and in a timely fashion, while the emergency responders can fully comprehend and act on the commands even if they are unfamiliar with the scene.

While the disclosure has been described by way of example and in terms of preferred embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A command assignment method, comprising:
a command assignment system with a screen display, wherein the command assignment system is capable of receiving a responder device location information from a responder device located in a scene and interacting with a responder interface of the responder device;
displaying a floor plan diagram corresponding to the scene on the screen display;
displaying a responder symbol on the floor plan diagram according to the responder device location information;
generating a destination correlation information in response to detecting a correlation operation between the responder symbol and a destination on the floor plan diagram;
displaying one or more action items on the screen display;
generating an action information in response to detecting an assignment operation with respect to the one or more action items;
generating a command information according to the destination correlation information and the action information; and
transmitting a command signal comprising the command information to the responder device to interact with the responder interface of the responder device through the command assignment system.

2. The command assignment method of claim 1, wherein the command assignment system comprises an equipment data module comprising one or more equipment location information of one or more equipment located in the scene, displaying the responder symbol comprises:
displaying a personnel symbol on the floor plan diagram according to the responder device location information;
displaying one or more equipment symbols on the floor plan diagram according to the one or more equipment location information;
generating a responder correlation information in response to detecting a correlation operation between the personnel symbol and the one or more equipment symbols; and
displaying the responder symbol on the floor plan diagram according to the responder correlation information.

3. The command assignment method of claim 1, wherein displaying the one or more action items comprises:
displaying a pop-up window on the screen display; and
displaying the one or more action items on the pop-up window.

4. The command assignment method of claim 1, wherein the assignment operation comprises receiving an input with respect to the one or more action items.

5. The command assignment method of claim 1, wherein the screen display is a touch-sensitive display, the responder symbol is a graphical, interactive user-interface object moved in accordance with a contact with the touch-sensitive display, the correlation operation between the responder symbol and the destination on the floor plan diagram comprises a movement of the responder symbol with respect to the destination.

6. The command assignment method of claim 1, further comprising displaying an assignment list comprising one or more assignment items generated according to the command information.

7. The command assignment method of claim 6, further comprising:
displaying the one or more action items in response to detecting a selection operation with respect to the one or more assignment items; and
generating the action information in response to detecting the assignment operation with respect to the one or more action items.

8. The command assignment method of claim 1, wherein each of the steps is an instruction stored in a computer readable storage medium.

9. A graphical user interface of a command assignment system with a screen display, the command assignment system being capable of receiving a responder device location information from a responder device located in a scene and interacting with a responder interface of the responder device, the graphical user interface comprising:
a floor plan diagram displayed corresponding to the scene on the screen display;
a responder symbol displayed on the floor plan diagram according to the responder device location information; and
one or more action items displayed on the screen display;
wherein a correlation operation can be performed between the responder symbol and a destination on the floor plan diagram, such that the command assignment system generates a destination correlation information when the correlation operation is detected by the command assignment system, an assignment operation can be performed with respect to the one or more action items, such that the command assignment system generates an action information when the assignment operation with respect to the one or more action items is detected by the command assignment system, generates a command information according to the destination correlation information and the action information, and transmits a command signal comprising the command information to the responder device to interact with the responder interface of the responder device through the command assignment system.

10. The graphical user interface of claim 9, wherein the command assignment system comprises an equipment data module comprising one or more equipment location information of one or more equipment located in the scene, the graphical user interface further comprising:
a personnel symbol displayed on the floor plan diagram according to the responder device location information;
one or more equipment symbols displayed on the floor plan diagram according to the one or more equipment location information;
wherein a correlation operation can be performed between the personnel symbol and the one or more equipment symbols, such that the command assignment system generates a responder correlation information when the correlation operation between the personnel symbol and the one or more equipment symbols is detected by the command assignment system, the responder symbol is displayed on the floor plan diagram according to the responder correlation information.

11. The graphical user interface of claim 9, the graphical user interface further comprising a pop-up window displayed in response to detecting the establishment of the correlation between the responder symbol and the destination on the floor plan diagram, wherein the one or more action items are displayed on the pop-up window.

12. The graphical user interface of claim 9, wherein the screen display is a touch-sensitive display, the responder symbol is a graphical, interactive user-interface object moved in accordance with a contact with the touch-sensitive display, the correlation operation between the responder symbol and the destination on the floor plan diagram comprises a movement of the responder symbol with respect to the destination.

13. The graphical user interface of claim 9, further comprising an assignment list comprising one or more assignment items generated according to the command information.

14. The graphical user interface of claim 13, wherein the one or more action items are displayed when a selection operation with respect to the one or more assignment items is detected by the command assignment system, such that the command assignment system generates the action information in response to detecting the assignment operation with respect to the one or more action items.

15. A command assignment device receiving a responder device location information from a responder device located in a scene, comprising:
a screen display;
a processing unit;
a storage unit; and
one or more software modules stored in the storage unit and configured for execution by the processing unit, the one or more software modules comprising instructions:
to display a floor plan diagram corresponding to the scene on the screen display;
to display a responder symbol on the floor plan diagram according to the responder device location information;
to generate a destination correlation information in response to detecting a correlation operation between the responder symbol and a destination on the floor plan diagram;
to display one or more action items on the screen display;
to generate an action information in response to detecting an assignment operation with respect to the one or more action items;
to generate a command information according to the destination correlation information and the action information; and
to transmit a command signal comprising the command information to the responder device to interact with a responder interface of the responder device.

16. The command assignment device of claim 15, further comprising an equipment data module comprising one or more equipment location information of one or more equipment located in the scene, wherein the instruction to display the responder symbol comprises:
to display a personnel symbol on the floor plan diagram according to the responder device location information;
to display one or more equipment symbols on the floor plan diagram according to the one or more equipment location information;
to generate a responder correlation information in response to detecting a correlation operation between the personnel symbol and the one or more equipment symbols; and
to display the responder symbol on the floor plan diagram according to the responder correlation information.

17. The command assignment device of claim 15, wherein the instruction to display the one or more action items comprises:
to display a pop-up window on the screen display; and
to display the one or more action items on the pop-up window.

18. The command assignment device of claim 15, wherein the screen display is a touch-sensitive display, the responder symbol is a graphical, interactive user-interface object moved in accordance with a contact with the touch-sensitive display, the correlation operation between the responder symbol and the destination on the floor plan diagram comprises a movement of the responder symbol with respect to the destination.

19. The command assignment device of claim 15, the one or more software modules further comprising an instruction to display an assignment list comprising one or more assignment items generated according to the command information.

20. The command assignment device of claim 19, the one or more software modules further comprising instructions:
to display the one or more action items in response to detecting a selection operation with respect to the one or more assignment items; and
to generate the action information in response to detecting the assignment operation with respect to the one or more action items.
